(19) United States
(12) Patent Application Publication
(10) Pub. No.: US 2014/0179359 A1
(43) Pub. Date: Jun. 26, 2014

(54) MESSAGE ROUTER FOR CONCATENATED SMS

(71) Applicant: MARKPORT LIMITED, Dublin (IE)

(72) Inventors: Klaas WIJBRANS, Rijen (NL); Thijs VERMOOLEN, Zeist (NL); Boudewijn Van De Moesdijk, Lelystad (NL); Petr Havel, Ivancice (CZ)

(73) Assignee: MARKPORT LIMITED, Dublin (IE)

(21) Appl. No.: 13/723,824

(22) Filed: Dec. 21, 2012

(51) Int. Cl. H04W 4/14

(52) U.S. Cl. CPC H04W 4/14
USPC 455/466

(57) ABSTRACT

A message router comprises a message controller with service logic functions, and a state database. It receives and processes message segments, maintains state of single and concatenated messages, and applies services to the messages. A routing and discrimination engine accesses a selected state database among an associated database and distributed state databases. The controller operates in a transparent-relay mode in which a message is relayed to a network element and the response from the network element is returned directly to an originator. The relaying may be performed using SCCP relaying. The controller can operate in a transparent-proxy mode in which it generates a fresh message and sends it to a network element and receives the response from the network element, and in turn returns a response to the originator.

### INTRODUCTION

1. Field of the Invention

The invention relates to processing of messages such as SMS messages.

2. Prior Art Discussion

Control of SMS messages being sent and/or received allows operators to apply additional services to them. These services can have different ways of impacting the message, such as:
no impact, e.g. creating a message copy
message modification, e.g. inserting an advertisement into the message or forwarding a message and inserting a forwarding indication
message blocking, e.g. content control (keyword filtering)

A feature in 3GPP 23.040 allows mobile handsets to divide a long text message into multiple segments, and pass each segment as an individual SMS message into the mobile network. Only the receiving mobile handset is expected to collect all segments, and present them as a single message to the mobile recipient.

Within the operator's mobile network, this handling of multiple segments as an individual message can conflict with the goal of controlling the complete message in order to apply a service.

Currently SMS routers are used in practice to off-load SMSCs or to intercept SMS messages to allow for the creation of additional services. Due to the nature of SMS standardization, these SMS routers are not able to transparently handle concatenated messages when service needs to be applied. All elements of the concatenated message are first retrieved and stored temporarily to be able to apply the appropriate service(s) on the complete message.

As a result, billing information and delivery reports are no longer correctly reflected to the originating handset or SMSC. No way to properly handle concatenated messages in a transparent manner was defined in standardization, and as a result even a newer standard like the IP-SM-GW now explicitly describes the non-transparent handling (TS23.204 section 6.9).

Main problems with this non-transparency include:
Billing between operators is based on the actual delivery outcome. By introducing non-transparency, the billing for the originating operator is no longer based on the actual delivery of the MT-FSM message. Moreover applying a non-transparent MT delivery behaviour breaks legislation for some European countries that requires that billing is applied for SMS throughout service when the message is actually delivered.
In many countries there are legal requirements that require a reliable indication (SMS notification) to the originator whether the SMS was actually delivered. Non-transparent behaviour breaks the possibility to commit to this legal requirement.

Due to non-transparency, it will either be very difficult (requiring changes to the operator inter-billing environments) or even not be possible (violation of the law) for operators to introduce advanced services in the MT path.

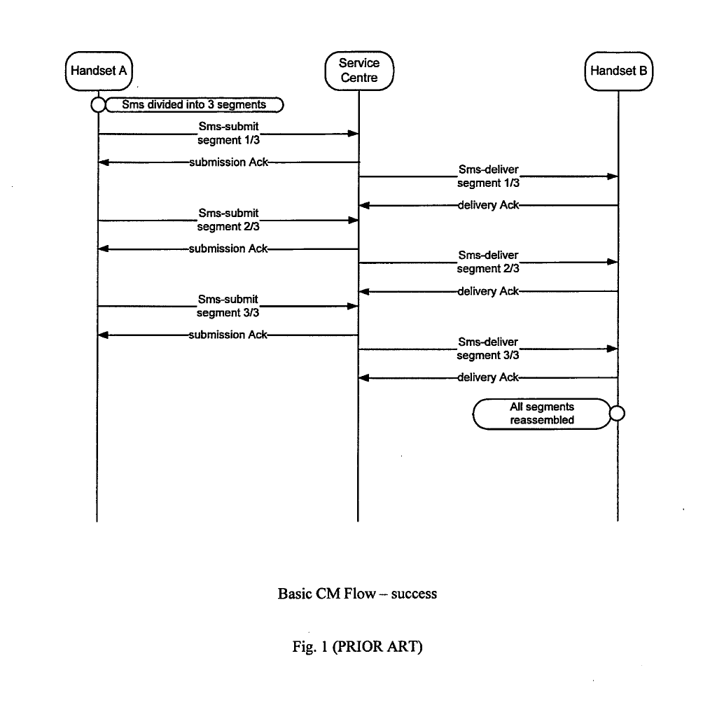

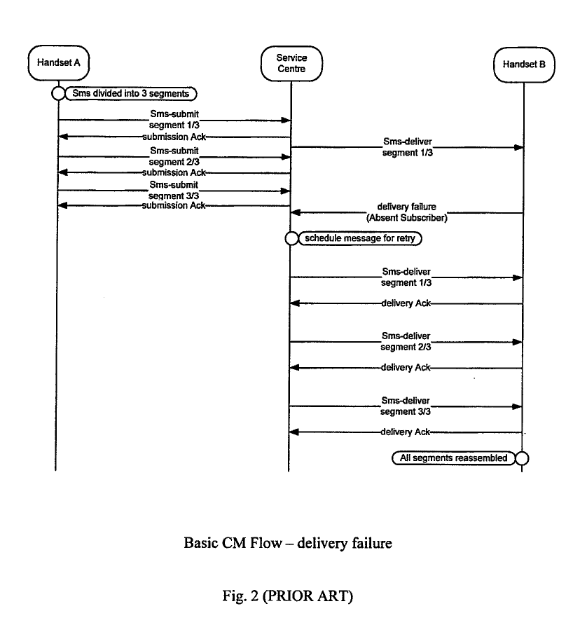

In a conventional mobile network the basic message flow of a CM is shown in FIG. 1 (success) and FIG. 2 (temporary delivery failure for first segment).

It should be noted that:
for each segment, the submission leg and delivery leg are independent (as Service Centre takes care of store+forward),
in the message submission leg, the submitting handset only starts sending a next segment once the acknowledgement of the Service Centre for the previous segment has been received, and
in the message delivery leg, the Service Centre will only attempt a delivery for a next segment, once the previous segment is reported as successfully delivered.

The timing as depicted in this flow is one of many variations. In principle, the timing of the delivery flows from the service center to handset B is totally de-coupled from the timing of the submission flow by handset A, with as the only constraint that the delivery of a segment to handset B cannot start before the Service Center has received it from the handset A.

There are no constraints in standardization that all segments go to the same Service Centre. For example, if handset A is moving and the Service Centres are bound to a specific region, it can occur that segment 1 is submitted to Service Center 1 and Segment 2/3 to Service Center 2 due to the handset crossing a geographical boundary and reconnecting to Service Center 2.

Due to the acknowledged nature of the protocol, it is unlikely that SMS segments will be submitted out of sequence into the network. The handset will only send a next segment after the previous segment was acknowledged successfully.

In addition, delivery may not be directly possible. In such a case, it can occur that the delivery of the first segment already fails, and the Servcie Center uses its retry schedule to deliver to the B handset (note: this scenario also shows how the de-coupling of submission and delivery as the Handset A will continue submitting regardless of the delivery attempts of the Service Center).

Though in theory segments could arrive out of sequence, in practice this does not often occur. In practice, in any SMSC the messages are ordered by B-party number to ensure in-sequence delivery of messages and multi-level routing or dedicated service center addresses are used to ensure that submitted messages to the same B party from various locations in the network are always sent to the same SMSC, thus ensuring that in practice all segments will be delivered in sequence as they are sent from the same SMSC.

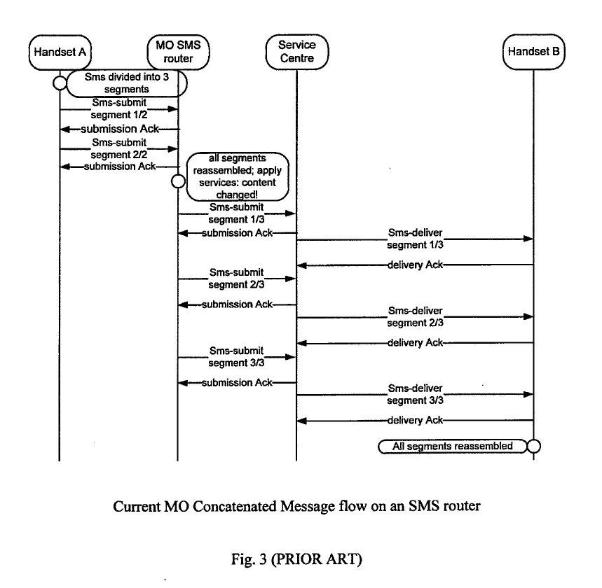

When an SMS router is put in the operator's network to control MO and MT message streams, the concatenated messages need to be stored before any service(s) can be applied to the full content of the message. This behavior is intrusive for the original message stream and causes billing problems for messages that require service(s). FIG. 3 is a depiction of the current functionality for MO concatenated messages that require service.

In the call flow diagram of FIG. 3 it is shown that all MO elements of the MO concatenated message are first being acknowledged (and stored) by the SMS router then the service is applied (i.e. archiving of the message), and then the original message is handed over towards the operators service centre for storage and MT delivery.

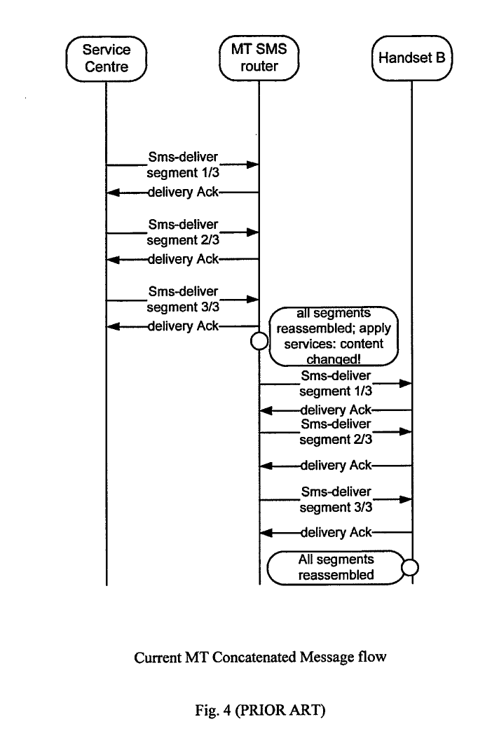

For MT FIG. 4 depict the current implementation. The MT flow is slightly more complicated: whereas in the MO flow the SMS router resides in the same network as the Service Center, in the MT flow often the SMS router is located in another network than the Service Center.

The invention addresses the problem of non-transparency in processing of concatenated messages.

### SUMMARY OF THE INVENTION

According to the invention, there is provided a message router comprising a message controller with service logic functions, and a state database, wherein the controller is adapted to:
receive and process message segments,
maintain state of single and concatenated messages, and to
apply services to said messages.

In one embodiment, the router further comprises a routing and discrimination engine adapted to access a selected state database among an associated database and distributed state databases.

In one embodiment, the message controller is adapted to operate in a transparent-relay mode in which a message is relayed to a network element and the response from the network element is returned directly to an originator.

In one embodiment, the relayed message is a MAP message or its equivalent.

In one embodiment, the relaying is performed using SCCP relaying.

In one embodiment, the controller is adapted to operate in a transparent-proxy mode in which the controller generates a fresh message and sends it to a network element and receives the response from the network element, and in turn returns a response to the originator.

In one embodiment, the message is a MAP message or its equivalent.

In one embodiment, the network element is a service centre or a switching centre.

In one embodiment, in the transparent relay mode the controller is adapted to perform the steps of:
receiving a segment of a concatenated message, and determining that a particular service needs to be applied on the originator of the message,
making a copy of this segment and placing this in the state database,
relaying the original message to its original destination, and the response from this destination is directly routed towards the original originator of the message,
receiving a subsequent segment and determining that this is a concatenated message and determining what service need to be applied, a subscriber service database indicating that an archive service needs to be applied and copying the message into the state database,
and the original messages is directly handed over towards the original destination, and
repeating these operation if another subsequent segment is received, and
checking that all elements have arrived in a temporary message storage in the state database, and
reassembling the full message context.

In one embodiment, the state database is selected based on the TP-OA, TP-DA and a concatenated short message reference number, which combination uniquely identifies a concatenated message from the originator device.

In one embodiment, the controller is adapted to use a distributed state database to operate when a subsequent segment arrives at the same SMS router instance or another SMS router instance.

In one embodiment, the controller is adapted to modify the message header to indicate that an additional segment will be part of the message.

In one embodiment, the service is an archive service.

In one embodiment, the service is modification of the content of the MO message, for example, introduction of an auto-signature into the message, or changing of the TP-OA to an alias.

In one embodiment, upon receipt of the first segment, the controller is adapted to store characteristics of the message in the state database and the auto-signature modification planned on the message.

In one embodiment, for a last segment, the controller is adapted to create a new segment containing the last of the contents concatenated with the start of the modified content, such as the auto-signature, and the controller is adapted to emit a new PDU towards the network element with this content and wait for the response of the network element.

In one embodiment, if the acknowledge of the network element is positive, the controller is adapted to change contents of a previously received segment to indicate that the current segment is the last and will add a tail of the auto-signature to the contents.

In one embodiment, the router controller further comprises a discriminator function to check with the state database whether processing of this message is in progress, and wherein the state database is adapted to indicates which service is in progress.

In one embodiment, for an intermediate segment a message reference is used that was not used by the device in the previous segments and a request for a status report is switched off, thus ensuring that status reports are only generated for the segments for which the originating device requested a status report and that the message reference still matches with the device-generated message reference, thus uniquely identifying a message submit operation.

In one embodiment, when operating in the proxy mode, the response is known to the router and the controller is adapted to act upon it according to the determined service.

In one embodiment, the controller is adapted to archive messages that were accepted by a service centre instead of submitted by a user device, based on knowledge as to whether the service centre accepted the message.

In one embodiment, the service is adding of content in the message.

In one embodiment, the router is adapted to perform the steps of:
receiving a message segment,
determining from a service database what service needs to be applied, in this case
addition of content for the recipient of the message,
reserving an entry in the state database for this message, storing the content and the original message,
modifying the original segment count to indicate the increased size to the receiving user device, creating text of the segment and sending it to the user device, and if this is a subsequent segment the response is used to determine whether to sent the original segment with adapted text) as well and if not it is directly returned as a negative response to the originating service centre,
receiving subsequent segments from the service centre and determining from the state database that that text modification is in progress and using the text segment and content stored in the database to create a next text segment to be sent to the user device, and
delivering this segment to the user device, and
returning the response form the user device to the service centre.

In one embodiment, the router is adapted to generate additional segments in the message when the additional content is being inserted, or only at the end.

In one embodiment, by retaining this state, if the message cannot be delivered to the user device or the response towards the service centre is lost, in the case of a retry the same modification can be re-applied towards the same segment.

In one embodiment, the controller is adapted to deliver the message segments to ensure that delivery reports generated by the originating service centre are still correct, even though the concatenated message is diverted to another user device and content indicating the diversion is pre-pended to the message.

In one embodiment, if the service database indicates that a diversion service needs to be applied on the recipient of the message from B to C the controller is adapted to create a new segment containing the diversion text, making use of the fact that the new segment does not have to be full but can contain only the necessary character, and the fact that this diversion is in progress is stored in the state database.

In one embodiment, the controller is adapted to perform content control in which:
at a first received message segment, an additional segment is inserted in a maximum segment count and this segment is used to cater for partial matches of forbidden content,
for each segment, the content is searched for ‘trigger’ keywords or phrases and if no phrase match is found the segment is passed as it is.
if a match is found, the appropriate content control action is taken such as do not deliver, or modify the text,
if a partial match is found at the end of a segment, the beginning of the segment is sent out, and the tail of the segment is stored in the state database,
when the next segment arrives, the partial match and the contents of the new segment are searched for violations,
this procedure continues until all segments have been passed through the router, and by reserving any extra segment it is possible to not send out potential matches at the end of the text and instead, this text is retained until the next segment arrives and only then checked again when the full context is known.

In one embodiment, the controller is adapted to handle out of sequence segments.

In one embodiment, the controller is adapted to add any modifications only to the head of the message, as only the first segment contains information on the nature of the pay-load of a message.

In another aspect, the invention provides a computer program product comprising a computer usable medium having a computer readable program code embodied therein, said program code being adapted to be executed to:
receive and process message segments,
maintain state of single and concatenated messages, and
apply services to said messages.

In another aspect, the invention provides a method of operation of a message router comprising a message controller with service logic functions, and a state database, the method comprising the steps of:
receiving and processing message segments,
maintaining state of single and concatenated messages, and
applying services to said messages.

The invention also provides other method aspects as set out above in the various embodiments

### DETAILED DESCRIPTION OF THE INVENTION

The invention will be more clearly understood from the following description of some embodiments thereof, given by way of example only with reference to the accompanying drawings in which:—

FIGS. 1 to 4 are message flows of the prior art as outlined above;

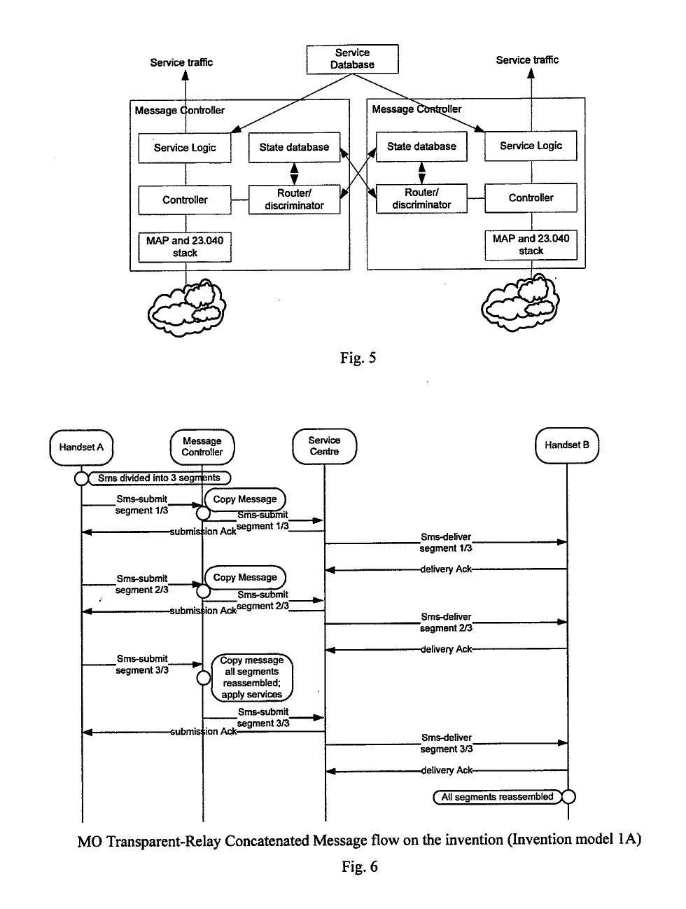

FIG. 5 is a diagram illustrating architecture of an SMS router of the invention;

FIG. 6 is a sequence diagram for MO transparent-relay concatenated message flow;

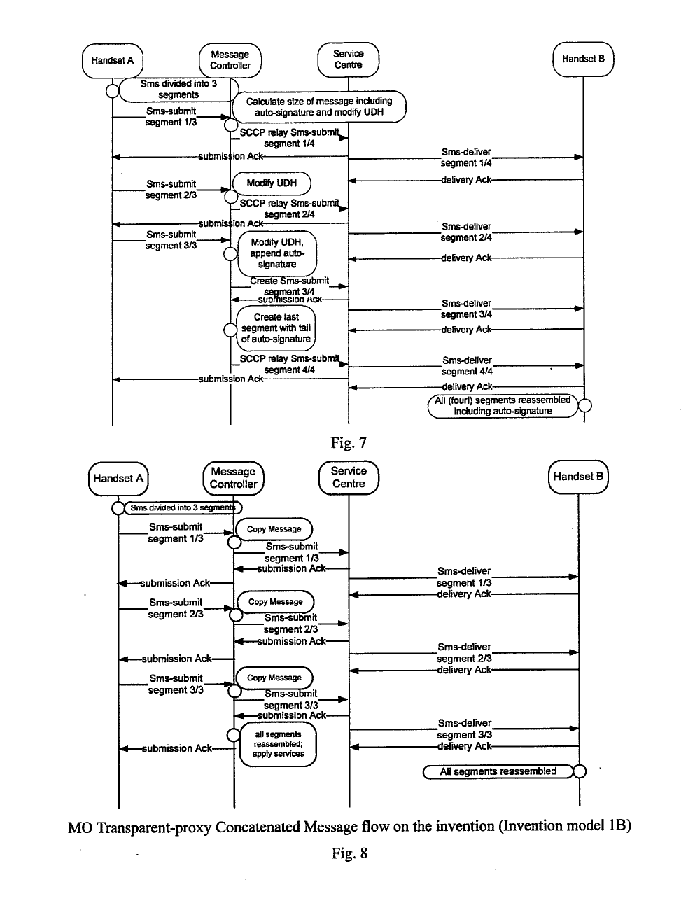

FIG. 7 is a sequence diagram showing a flow with the introduction of an auto-signature;

FIG. 8 is a sequence diagram showing MO transparent-proxy concatenated message flow in another embodiment;

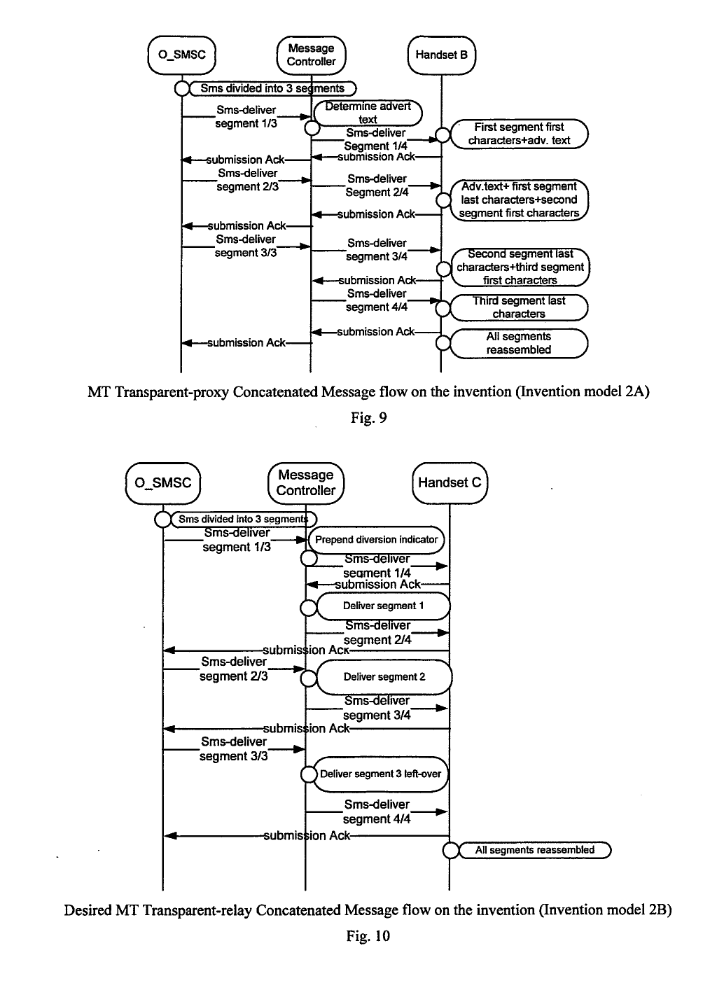

FIG. 9 shows MT transparent-proxy concatenated message flow; and

FIG. 10 shows desired MT transparent-relay concatenated message flow.

### GLOSSARY OF TERMS AND THEIR DEFINITIONS

| Acronym | Meaning | Explanation |
|---|---|---|
| MO | Mobile Originated | SMS message from a mobile to an |
| | | SMSC |
| MT | Mobile Terminated | SMS messages from an SMSC to a |
| | | mobile |
| CM | Concatenated Message | SMS messages consisting of multiple |
| | | SMS |
| 3GPP | 3rd Generation | Standard for G3 network |
| | Partnership Project | |
| TP-DA | TP-Destination | Destination Address in an 23.040 |
| | Address | SMS PDU |
| TP-OA | TP-Originator | Originator Address in an 23.040 |
| | Address | SMS PDU |
| TP-MR | TP-Message Reference | Message Reference number in an |
| | | 23.040 SMS PDU |
| UD | User Data | The User Data (pay-load) of a 3GPP |
| | | TS23.040 SMS message PDU. |
| UDH | User Data Header | First bytes of the user data field |
| | | (Message Text Field) that provides |
| | | information on for example segmen- |
| | | tation and other information on the |
| | | properties of the User Data |
| SMS | | Component capable of handling the |
| router | | SMS protocol without the store & |
| | | forward capability that is standar- |
| | | dized as part of an Service Center. |
| Trans- | | A transparency mode where the SMS |
| parent- | | router relays the MAP message using |
| relay | | SCCP relaying to the Service |
| | | Center/MSC and the response from |
| | | the Service Center/MSC is returned |
| | | directly towards the originator of |
| | | the request bypassing the router. |
| Trans- | | A transparency mode where the SMS |
| parent- | | router emits a new MAP message to |
| proxy | | the Service Center/MSC, the |
| | | response from the Service Center/ |
| | | MSC is returned towards the router |
| | | and the router then returns the |
| | | response to the original request |
| | | to the originator. |

The invention achieves handling of the SMS messages transparently towards the network, while at the same time allowing services on the message as a whole.

An SMS router of the invention has conventional hardware components, and additional functionality illustrated in FIG. 5, including:
a state database, maintaining state of (single) and concatenated SMS messages being sent through the network,
service logic, allowing for the application of services on single and concatenated SMS messages and with an interface for serviced traffic (e.g., message copies),
a routing and discrimination engine, allowing for the selection of a specific state database in a distributed implementation of the invention,
SMS interface, providing the 29.002 MAP interface and the 23.040 SMS encoding,
a controller, responsible for the finite state machine/flow through the various components, and
an (external) service database, indicating which services to apply to which subscriber.

In order to become less intrusive for the original message flow it is proposed with this invention to handle concatenated messages and apply their service(s) in the following way. The call flows discriminate on two different types of handling for MO (Scenario 1A & 1B) and MT (Scenario 2A & 2B) concatenated messages:
Transparent-relay (see Glossary)
Transparent-proxy (see Glossary)
   Use case of Invention 1A & 1B (Mobile Originated)

FIG. 6: MO Transparent-Relay Concatenated Message flow on the invention (Invention model 1A), FIG. 8 MO Transparent-proxy Concatenated Message flow on the invention (Invention model 1B) describe the desired implementation and handling for these two types (Transparent-relay and Transparent-proxy) of concatenated messages where service(s) needs to be applied in the MO leg of the SMS message (i.e. an archive service).
The SMS router receives segment 1 of 3 (where the UDH indicates to the invention that this is a concatenated message). The router triggers to determine what service needs to be applied. The service database indicates that an archive service needs to be applied on the originator of the message. (Not depicted)
The SMS router makes a copy of this segment message and places this in the state database. The state database is selected by the router/discriminator based on the TP-OA, TP-DA and the ‘Concatenated short message reference number’ (the first octet of the concatenation IEI field). This combination uniquely identifies a concatenated message from the Handset A (note TP-MR cannot be used as it is incremented for each segment).
The router will now SCCP relay the original message to its original destination (Local SMSC). The response from this destination is directly routed towards the original originator of the message.
The router receives segment 2 of 3. UDH indicates that this is a concatenated message and triggers the subscriber service database to understand what service(s) need to be applied. (Not depicted)
The subscriber service database again indicates that an archive service needs to be applied and the invention will copy the message into the appropriate state database using the procedure described above. After that the original messages is directly handed over towards the original destination (Local SMSC). Note the second segment can arrive at the same SMS router instance or another SMS router instance, this is why the router/discriminator together with the distributed state database is of importance.
The router receives segment 3 of 3. UDH indicates that this is a concatenated message and triggers the subscriber service database to understand what service(s) need to be applied. (Not depicted)
The subscriber service database indicates that an archive service needs to be applied and the invention will copy the message into the appropriate state database using the procedure described above for reassembly. After that the original messages is directly handed over towards the original destination (Local SMSC)
The router controller will see that all elements have arrived in the temporary message storage in the state database (Based on the UDH information) and will now start to reassemble the full message context. This can now be included in the service traffic interface towards an external system to apply the archive service.

This procedure will copy any attempt to submit a concatenated message by the handset regardless of whether the service center accepts it. In practice, this may not always be desirable for a copy service, and in that case the next flow may be more appropriate.

An alternative function for which the above flow can be used are modifications to the content of the MO message, for example, the introduction of an auto-signature into the message, the changing of the TP-OA to an alias. The changing of the TP-OA to an alias is trivial as it consists of changing an existing field only and does not result in changes to the segmentation.

Handling of error situations: if the SMSC does not respond with an accept of the message but with a temporary error, the handset A will retry the sending of each not accepted segment. The SMS router detects this as the combination of TP-OA, TP-DA and ‘Concatenated short message reference number’ is already present in the database, thus ensuring that a copy of any submission attempt is created only once.

As an example, the introduction of an auto-signature (which combines the generation of an additional message segment in proxy mode with the submission of the original segments in relay mode) is given in FIG. 7.

Referring to FIG. 7:
The router receives segment 1 of 3 (where the UDH indicates to the invention that this is a concatenated message) the invention triggers the service database to determine what service needs to be applied. The service database indicates that an auto-signature service needs to be applied on the originator of the message.
The router will now store the characteristics of the message in the state database and the auto-signature modification planned on the message (extending it with a number of characters). The state database in a specific instance (in the case of a distributed implementation) is selected by the router/discriminator based on the TP-OA, TP-DA and the ‘Concatenated short message reference number’ (the first octet of the concatenation IEI field). This combination uniquely identifies a concatenated message from the Handset A (note TP-MR cannot be used as it is incremented for each segment).
The router will now modify the UDH in the message to indicate that an additional segment will be part of the message (i.e., segment 1 of 4) and SCCP relay the original message to its original destination (Local SMSC). The response from this destination is directly routed towards the original originator of the message. It is always necessary to reserve space for the additional segment as it is known at segment 1 what the total length of the message is (i.e., whether the last segment has sufficient room available for the auto-signature or not).
The router receives segment 2 of 3. UDH indicates that this is a concatenated message. The controller uses the Router/Discriminator to check with the state database whether processing of this message is in progress.
The state database indicates that processing is in progress, in this case an auto-signature is being applied. The controller will change the UDH of this message to indicate that it is segment 2 of 4 and SCCP relay the resulting PDU to the Service Center.
The router receives segment 3 of 3. UDH indicates that this is a concatenated message. The controller uses the Router/Discriminator to check with the state database whether processing of this message is in progress.
The state database indicates that processing is in progress, in this case an auto-signature is being applied. As this is the last segment, the controller will create a new segment containing the last of the contents concatenated with the start of the auto-signature that still fits in the segment, with as its segment indication segment 3 of 4. The controller emits a new PDU towards the Service Centre with this content and waits for the response of the Service Centre.
If the acknowledge of the Service Centre is positive, the controller with change the contents of the previously received segment to indicate segment 4 of 4 and will add the tail of the auto-signature to the contents. It will then SCCP relay the resulting PDU to the Service Centre.
The Service Centre acknowledges this final PDU to the handset.

As a result of this way of operating, the content of the message was successfully changed while minimizing the total number of SS7 PDUs needed through the use of SCCP relaying. Care must be taken that in the intermediate segment a TP-MR is used that is not used by the handset in the previous segments and that a request for a status report is switched off. This ensures that status reports are only generated for the segments for which the originating handset requested a status report and that the TP-MR still matches with the handset generated TP-MR thus uniquely identifying the SMS-SUBMIT.

Error situations are handled correctly as the state is retained for the validity period of the message, thus ensuring that if a segment is re-submitted the same modifications are applied to the segment again.

When operating in proxy mode, the response is known to the SMS router as well and it can act upon it. Proxy mode is also mandatory if the MAP versions between handset A and the message router of the invention and between the message router of the invention and Service Center are not the same.
The router receives segment 1 of 3 (where the UDH indicates to the invention that this is a concatenated message) invention triggers to determine what service needs to be applied. The service database indicates that an archive service needs to be applied on the originator of the message. (Not depicted)
The router will now make a copy of this segment and places this in the state database. The state database in a specific invention instance (in the case of a distributed implementation) is selected by the router/discriminator based on the TP-OA, TP-DA and the ‘Concatenated short message reference number’ (the first octet of the concatenation MI field). This combination uniquely identifies a concatenated message from the Handset A (note TP-MR cannot be used as it is different for each segment).
The router will now proxy the original message to its original destination (Local SMSC). The response from this destination is returned by the invention towards the original originator of the message.
The router receives segment 2 of 3. UDH indicates that this is a concatenated message and triggers the subscriber service database to understand what service(s) need to be applied. (Not depicted)
The subscriber service database again indicates that an archive service needs to be applied and the invention will copy the message into the appropriate state database using the procedure described above. After that the response is returned by the invention to the original originator. Note the second segment can arrive at the same invention instance or another invention instance, this is why the router/discriminator together with the distributed state database is of importance.
The router receives segment 3 of 3. UDH indicates that this is a concatenated message and triggers the subscriber service database to understand what service(s) need to be applied. (Not depicted)
The subscriber service database indicates that an archive service needs to be applied and the invention will copy the message into the appropriate state database using the procedure described above for reassembly. After that the original message is proxied over towards the original destination (Local SMSC) and the response of the SMSC is returned by the invention to the originating handset.
The router controller will see that all elements have arrived in the temporary message storage in the state database (based on the UDH information) and will now start to reassemble the full message context. This can now be included in the service traffic interface towards an external system to apply the archive service.

The proxy case is especially of interest for archiving all messages that were accepted by the Service Centre instead of submitted by the handset, as in this case the invention has knowledge whether the Service Centre accepted the message.

Use case of Invention 2A & 2B (Mobile Terminated) In the call flow diagrams FIG. 9: MT Transparent-proxy concatenated Message flow on the invention (Invention model 2A), FIG. 10: Desired MT Transparent-relay Concatenated Message flow on the invention (Invention model 2B) the desired implementation for handling concatenated MT messages where service(s) need to be applied is depicted and described in each figure.

An example is an MT-advertising service which inserts an additional text (before, after or in the middle of the message) when delivering to the B-handset (the flow shows somewhere in the middle of the first segment, but in principle it can be in any location).
The router receives segment 1 of 3 (UDH indicates to the invention that this is a concatenated message) The invention consults the service database to determine what service needs to be applied. The service trigger response indicates that an advertising service needs to be applied on the recipient of the message. Based on this, it will reserve an entry in the state database for this message, store the advertisement text and the original message.
The router will modify the original segment count to indicate the increased size to the receiving handset. The text of the segment is created (by appropriately mixing the advertisement text and the original text) and sent to the handset. If this is the extra segment, the response is used to send also determine whether to sent the original segment (with adapted text) as well. If not, it is directly returned as a negative response to the originating Service Centre which will go in retry mode.
The router receives segment 2 of 3 from the service centre. UDH indicates that this is a concatenated message and looks up the state database to determine which service is pending.
The state database indicates that that text modification is in progress and will use the text segment and advertisement text stored in the database to create the next text segment to be sent to the handset, including the increased segment count in the UDH. This segment is delivered to Handset B. The response of Handset B is returned to the Service Center.
The router receives segment 3 of 3. UDH indicates that this is a concatenated message and looks up the state database to determine which service is pending. The state database indicates that that text modification is in progress and will use the text segment and advertisement text stored in the database to create the next text segment to be sent to the handset, including the increased segment count in the UDH. This segment is delivered to Handset B.
As this is the ‘extra’ segment, the fact that it is sent out is stored in the state database. The original segment 3 of 3 is modified to 4 of 4 and the left-over text of segment 3 is inserted in it and delivered to the handset.
The response of Handset B is returned to the Service Centre, finalizing this transfer.

Though in the flow, the advertisement segment is shown at the start of the message, in principle it can be inserted in any location in the message (at the front, in the middle, at the back). To allow for that, the state database stores the advertisement text, the character location at which the advertisement text needs to be inserted and the ‘left-over’ text of the original segment which was replaced by the advertisement text.

Additional segments can be generated in the middle of the message at the moment the advertisement text is being inserted, or only at the end as indicated in the MO flow.

By retaining this state, if the message cannot be delivered to the handset or the response towards the service centre is lost, in the case of a retry the same modification can be re-applied towards the same segment.

In case the advertisement was not applied yet, and a retry occurs after significant time, the advertisement text can be refreshed by only reserving the amount of data to be inserted at the initial segment and requesting the advertisement text only when it is really needed, ensuring that advertisements can be tailored to time of day and subscriber location.

### MT Transparent Relay—Diversion Case

In this case, transparent relay is used for the delivery of the actual message segments. This ensures that the delivery reports (which are generated by the originating SMSC) are still correct, even though the concatenated message is diverted to another user and a text indicating the diversion (e.g., ‘Divert from <B>:’) is pre-pended to the actual message text.
The router receives segment 1 of 3 (UDH indicates to the invention that this is a concatenated message). The invention looks up the service database to determine what service needs to be applied. The service database indicates that a diversion service needs to be applied on the recipient of the message from B to C. The SRI to determine whether the C handset is in coverage is not shown in the flow for clarity.
The router will now create a new segment containing the diversion text, making use of the fact that the new segment does not have to be full but can contain only the necessary characters. The UDH is set to indicate that this is segment 1 of 4. The fact that this diversion is in progress is stored in the state database.
The router delivers the segment to the handset and updates the state database to indicate it was delivered successfully.
The router will now SCCP relay the original message to the MSC for delivery to its diverted destination handset C, updating the UDH to indicate segment 2 of 4. The response from this destination is directly relayed towards the original originator as it does not contain information identifying that the response came from C instead of from B.
The router receives segment 2 of 3. UDH indicates that this is a concatenated message and triggers the state database to understand what service(s) is in progress.
The state database indicates that a diversion service needs to be applied and that the extra segment and the initial segment were already delivered to the handset. The invention will modify the UDH to indicate 3 of 4 and SCCP relay the message to the MSC for delivery to handset C. The MSC returns the response directly to the originating SMSC.
The router receives segment 3 of 3. UDH indicates that this is a concatenated message and triggers the state database to understand what service(s) is in progress.
The state database indicates that a diversion service needs to be applied and that the extra segment and the initial segment were already delivered to the handset. The invention will modify the UDH to indicate 4 of 4 and SCCP relay the message to the MSC for delivery to handset C. The MSC returns the response directly to the originating SMSC.

In the diversion case, the insertion of the Diversion information in the SMS is not always this trivial:
If a UDH is present containing more information, this UDH needs to be part of the first segment still and the diversion indicator appended. The second segment then is shortened to contain only the concatenation indicator in the UDH and the original segment text.
If the UDH contains EMS formatting information, the offsets for the formatting need to be changed to take the additional inserted text into account.
If the diversion indicator is not in the GSM7 character set but in UCS2 and the original SMS is in GSM7, a significantly larger number of delivery SMS messages needs to be generated. The original content is converted to UCS. An additional segment is first sent for delivery containing the initial text of the SMS and then the tail of the content in the segment is relayed using SCCP relaying. This ensures consistency of billing information and delivery reports with the actually delivered end user segments.

### Content Control

In the content control case, the same procedure can be applied with an additional constraint that the messages must be in sequence. The procedure is described below:
At the first segment, an additional segment is inserted in the maximum segment count. This segment is used to cater for partial matches of forbidden content.
For each segment, the content is searched for ‘trigger’ keywords or phrases. Only partial matches can be made as a word may be ‘broken’ as part of the total content.
No phrase match was found at all, the segment is passed as is.
If a match was found, the appropriate content control action is taken (do not deliver, modify the text etc.).
If a partial match was found at the end of a segment, the beginning of the segment (+the final text of the previous segment if any) is sent out. The tail of the segment (the partial match) is stored in the state database.
When the next segment arrives, the partial match and the contents of the new segment are search for violations.
This procedure continues until all segments have been passed through the system.

By reserving the extra segment(s) it is possible to not send out potential matches at the end of the text. Instead, this text is retained until the next segment arrives and only then checked again when the full context is known. By this procedure, full content control is possible while still acting transparently.

### Out of Sequence Segments

Though in practice, all segments will be sent in sequence as they will come from the same originating SMSC and will be ordered by TP-MR or time stamp, this is a good practice across all operators that is not pre-scribed in the standard.

However, also in the case of non in-sequence messages it is still possible to provide part of the functionality. The main restriction in that case is that any modifications must be made to the head of the message, as only the first segment contains information on the nature of the pay-load of a message (the full UDH).

The procedure when dealing with out of sequence messages is as follows:
When the first out-of-sequence segment is seen, an entry is allocated in the database and the service logic is checked to determine whether a service needs to be applied.
The maximum number of segments added by this service is determined (dependent on the size of the text/forwarding information to be added to the SMS). This information is stored in the state database.
The max sequence count and the sequence number of the SMS are increased by the number of additional segments to be inserted.
Any subsequent segment which is not the first segment is treated in the same manner.
When the first segment is received, the UDH is inspected. Dependent on the contents of the UDH (which text or binary SMS, which character set), the modifications are defined:
   In case of a binary SMS, no modification is possible so the original segment is split over the still available segments which are sent out in sequence (the newly generated segments in proxy mode, the original in relay or proxy mode but returning the actual delivery result to the originating SMSC).
   In case of a text SMS or EMS, taking the encoding into account a segment with the original UDH, but modified for the additional information is pre-pended (number of segments, in EMS also the character offsets for certain formatting). The new text is added after that in the appropriate character set encoding for as many segments as needed for the additional text.
   The original first segment text contents (and optionally additional text) are sent out and the result of this delivery is used to return to the originating SMSC.

By using this procedure, all text and EMS messages can still be modified (or transparently passed through if the conclusion is that they cannot be modified anymore), even if messages are not delivered in sequence. The main restriction is that any modifications to the text must be in the same character encoding as the original SMS message.

The invention is not limited to the embodiments described but may be varied in construction and detail.

1-40. (canceled)

41. A message router comprising a message controller with service logic functions, and a state database, wherein the controller is adapted to:
receive and process message segments,
maintain in the state database state of single and concatenated messages, and to
apply services to said messages;
wherein the message router further comprises a routing and discrimination engine adapted to access a selected state database among an associated database and distributed state databases;
wherein the message controller is adapted to operate in a transparent-relay mode in which a message is relayed to a service centre or switching centre network element and the response from the network element is returned directly to an originator; and
wherein the controller is adapted to operate in a transparent-proxy mode in which the controller generates a fresh message and sends it to a service centre or switching centre network element and receives the response from the network element, and in turn returns a response to the originator;
wherein, when operating in the proxy mode, the response is known to the router and the controller is adapted to act upon it according to the determined service.

42. The message router as claimed in claim 41, wherein the relayed message is a MAP message or its equivalent; and wherein the relaying is performed using SCCP relaying.

43. The message router as claimed in claim 41, wherein in the transparent relay mode the controller is adapted to perform the steps of:
receiving a segment of a concatenated message, and determining that a particular service needs to be applied on the originator of the message,
making a copy of this segment and placing this in the state database,
relaying the original message to its original destination, and
the response from this destination is directly routed towards the original originator of the message,
receiving a subsequent segment and determining that this is a concatenated message and determining what service need to be applied, a subscriber service database indicating that the service which needs to be applied is an archive service, or modification of content of the original message, or adding of content to the message and copying the message into the state database, and the original message is directly handed over towards the original destination, and repeating these operation if another subsequent segment is received, and
checking that all elements have arrived in a temporary message storage in the state database, and
reassembling the full message context.

44. The message router as claimed in claim 41, wherein the state database is selected based on the TP-OA, TP-DA and a concatenated short message reference number, which combination uniquely identifies a concatenated message from the originator device, wherein the controller is adapted to use a distributed state database to operate when a subsequent segment arrives at the same SMS router instance or another SMS router instance, wherein the controller is adapted to modify the message header to indicate that an additional segment will be part of the message.

45. The message router as claimed in claim 43 wherein, upon receipt of the first segment, the controller is adapted to store characteristics of the message in the state database and the modification planned on the message, wherein for a last segment, the controller is adapted to create a new segment containing the last of the contents concatenated with the start of the modified content, and the controller is adapted to emit a new PDU towards the network element with this content and wait for the response of the network element, and wherein if the acknowledge of the network element is positive, the controller is adapted to change contents of a previously received segment to indicate that the current segment is the last and will add a tail of the auto-signature to the contents.

46. The message router as claimed in claim 41, further comprising a discriminator function to check with the state database whether processing of this message is in progress, and wherein the state database is adapted to indicates which service is in progress.

47. The message router as claimed in claim 41, wherein the controller is adapted to archive messages that were accepted by a service centre instead of submitted by a user device, based on knowledge as to whether the service centre accepted the message.

48. The message router as claimed in claim 43, wherein the router is adapted to perform the steps of:
receiving a message segment,
determining from a service database what service needs to be applied, in this case addition of content for the recipient of the message,
reserving an entry in the state database for this message,
storing the content and the original message,
modifying the original segment count to indicate the increased size to the receiving user device, creating text of the segment and sending it to the user device, and if this is a subsequent segment the response is used to determine whether to sent the original segment with adapted text) as well and if not it is directly returned as a negative response to the originating service centre,
receiving subsequent segments from the service centre and determining from the state database that that text modification is in progress and using the text segment and content stored in the database to create a next text segment to be sent to the user device, and
delivering this segment to the user device, and
returning the response form the user device to the service centre.

49. The message router as claimed in claim 48, wherein the router is adapted to generate additional segments in the message when the additional content is being inserted, or only at the end; and wherein by retaining this state, if the message cannot be delivered to the user device or the response towards the service centre is lost, in the case of a retry the same modification can be re-applied towards the same segment.

50. The message router as claimed in claim 41, wherein the controller is adapted to deliver the message segments to ensure that delivery reports generated by the originating service centre are still correct, even though the concatenated message is diverted to another user device and content indicating the diversion is pre-pended to the message; and wherein if the service database indicates that a diversion service needs to be applied on the recipient of the message from B to C the controller is adapted to create a new segment containing the diversion text, making use of the fact that the new segment does not have to be full but can contain only the necessary character, and the fact that this diversion is in progress is stored in the state database.

51. The message router as claimed in claim 41, wherein the controller is adapted to perform content control in which:
at a first received message segment, an additional segment is inserted in a maximum segment count and this segment is used to cater for partial matches of forbidden content,
for each segment, the content is searched for ‘trigger’ keywords or phrases and if no phrase match is found the segment is passed as it is.
if a match is found, the appropriate content control action is taken such as do not deliver, or modify the text,
if a partial match is found at the end of a segment, the beginning of the segment is sent out, and the tail of the segment is stored in the state database,
when the next segment arrives, the partial match and the contents of the new segment are searched for violations,
this procedure continues until all segments have been passed through the router, and by reserving any extra segment it is possible to not send out potential matches at the end of the text and instead, this text is retained until the next segment arrives and only then checked again when the full context is known.

52. The message router as claimed in claim 41, wherein the controller is adapted to handle out-of-sequence segments; and wherein the controller is adapted to add any modifications only to the head of the message, as only the first segment contains information on the nature of the pay-load of a message.

53. A method of operation of a message router comprising a message controller with service logic functions, and a state database, the method comprising the steps of:
receiving and processing message segments,
maintaining in the state database state of single and concatenated messages, and
applying services to said messages;
wherein the controller accesses a selected state database among an associated database and distributed state databases;
wherein the message controller operates in a transparent-relay mode in which a message is relayed to a service centre or switching centre network element and the response from the network element is returned directly to an originator;
wherein the controller operates in a transparent-proxy mode in which the controller generates a fresh message and sends it to a service centre or switching centre network element and receives the response from the network element, and in turn returns a response to the originator
wherein, when operating in the proxy mode, the response is known to the router and the controller is adapted to act upon it according to the determined service.

54. The method as claimed in claim 53, wherein in the transparent relay mode the controller performs the steps of:
receiving a segment of a concatenated message, and determining that a particular service needs to be applied on the originator of the message,
making a copy of this segment and placing this in the state database,
relaying the original message to its original destination, and
the response from this destination is directly routed towards the original originator of the message,
receiving a subsequent segment and determining that this is a concatenated message and determining what service need to be applied, a subscriber service database indicating that an archive service needs to be applied and copying the message into the state database, and the original messages is directly handed over towards the original destination, and repeating these operation if another subsequent segment is received, and
checking that all elements have arrived in a temporary message storage in the state database, and
reassembling the full message context.

55. A computer program product comprising a computer usable medium having a computer readable program code embodied therein, said program code being adapted to be executed to perform the steps of a method of claim 53 when executed by a digital processor.
